(19) United States
(12) Patent Application Publication
(10) Pub. No.: US 2004/0102533 A1
(43) Pub. Date: May 27, 2004

(54) Method for upgrading composite materials and polyethylene terephthalate

(76) Inventors: Gerard Durand, Le Pecq (FR); Gilles Tersac, Champcueil (FR); Khalid El Gersifi, Chatenay-Malabry (FR)

Correspondence Address: Kilpatrick Stockton, Suite 2800, 1100 Peachtree Street, Atlanta, GA, 30309-4530, US

(21) Appl. No.: 10/332,117

(22) PCT Filed: Jul. 6, 2001
(86) PCT No.: PCT/FR01/02186

(30) Foreign Application Priority Data
Jul. 6, 2000 (FR) 0008845

(51) Int. Cl. C08J 11/04

(52) U.S. Cl. 521/40

(57) ABSTRACT

The invention concerns a method for upgrading composite materials and polyethylene terephthalate, which consists in carrying out solvolysis of the composite materials and polyethylene terephthalate, optionally in the presence of a catalyst, and in separating the product of the solvolysis containing the degradation products of the matrix of the composite materials and of the polyethylene terephthalate from the other constituents of the composite materials and other possible impurities from the polyethylene terephthalate.

The present invention relates to a method for upgrading (using) composite materials and polyethylene terephthalate. Such a method allows novel use of each of the constituent elements of the treated composite material and polyethylene terephthalate.

In the present application, the expression “composite material” is understood to mean any material comprising an organic matrix which is a heat-curable resin and at least one other component of a different nature. Advantageously, the composite materials which may be used in the method in accordance with the invention are materials comprising a matrix made of heat-curable resin which is reinforced with glass, boron, carbon or aramid, and which, in addition, can comprise metal plates.

Composite materials are very widely used given their excellent properties of mechanical and chemical resistance in numerous industries such as aeronautics, automobile, aerospace, construction, or civil engineering, in particular in the manufacture of pipes for transporting liquids, and electronics, in particular in electronic cards.

The recycling of composites is a current concern of industrialists. Indeed, products made from composite materials were previously discharged in rubbish dumps. However, currently, the number of rubbish dumps is in constant decline and the regulations relating to the treatment of waste are increasingly strict. It has therefore become imperative to develop methods of treating these composite materials.

Moreover, the extensive use of polyethylene terephthalate (PET), in particular for the manufacture of drinks bottles, requires high recycling costs.

As regards composite materials, three main upgrading (use) routes have been proposed:

by mechanical treatment;

by pyrrolysis;

by solvolysis.

Mechanical treatment consists in grinding the composite material which can then be used as reinforcing material in novel composite materials.

Treatment by pyrrolysis uses heating to very high levels in order to convert the composite material to inorganic residues, oils and gases which may be very toxic. The reinforcing fibers may be recovered; however, their mechanical properties are reduced.

Treatment by solvolysis of composites with matrix of the unsaturated polyester type has been described in patent applications EP 693527 and WO 94/25517. However, in the method described in patent application WO 94/25517, the fibers are mechanically separated from the matrix of the composite and glycolysis is performed on the composite powder freed from the reinforcing fibers. The method described in patent application EP 693527 envisages grinding the composite to very fine particles having a diameter of the order of a few hundreds of microns and then glycolysis of this ground material. Such methods do not allow recovery of the reinforcing fibers.

The products of degradation of the matrix of the composite materials by glycolysis are essentially polyols. An advantageous recycling route for these polyols would be the preparation of polyurethane foams. However, because of the high proportion of solvent used in solvolysis, these polyols contain solvent in free form; the polyols recovered thus have an excessively high hydroxyl value.

As regards polyethylene terephthalate, various sources of polyethylene terephthalate waste exist. One of the main sources is that of beverage packagings. The polyethylene terephthalate recovered by this source comprises numerous types of waste, such as in particular stoppers, adhesives and labels for packaging. Its recycling is however generally easier than that of the composite materials, although expensive.

The glycolysis of PET (polyethylene terephthalate), and most particularly of PET waste, is well known. Polyols are thereby obtained whose main application is the manufacture of rigid polyurethane foams after formulation and addition of isocyanate. However, the polyols obtained by mere glycolysis have defects.

These defects are mainly:

(i) an excessive viscosity;

(ii) a hydroxyl functionality equal to 2, leading to polyurethane materials lacking stiffness and to foams whose size stability is very low;

(iii) a defect of stability during storage of the polyols, resulting in the more or less rapid deposition of solid phases;

(iv) a low compatibility with certain foaming agents.

It is therefore necessary to correct these defects by process modifications. All the modifications envisaged up until now substantially increase the cost of manufacture of the polyols and/or the polyurethane foams.

The main modifications possible are the following:

coglycolysis with triols or polyhydroxylated molecules (glycerol, pentaerythritol, α-methylglucoside), as is described in patents U.S. Pat. No. 4,664,019 and U.S. Pat. No. 5,360,900. However, this modification increases the viscosity of the polyol, which induces high risks of instability during storage;

post-esterification with diacids (adipic, phthalic, and the like) which improves the stability during storage and reduces the viscosity, as is described in patents U.S. Pat. No. 4,559,370 and U.S. Pat. No. 4,539,341. However, this modification extends the process time and increases the cost of the raw materials;

post-treatment with an alkylene oxide (ethylene, propylene) which improves the stability during storage and reduces the viscosity, as is described in patent U.S. Pat. No. 4,701,477. In this case also, the process time is extended and specialist installations have to be used (exothermic reaction, pressurized reactors); post-distillation making it possible to remove the monoethylene glycol resulting from the glycolysis of PET, which makes it possible to improve the stability during storage, as described in patents U.S. Pat. No. 4,469,824 and U.S. Pat. No. 4,664,019. However, the process time is extended and a by-product is produced;

glycolysis with an excess of glycol, followed by vacuum distillation of the excess of free glycols. In this case, no reequilibrating reaction occurs which would make it possible to reduce the viscosity and improve the stability during storage in order to obtain a polyol having a narrower molecular distribution. These methods use distillation plants under high vacuum using a scraped film technique, as described in patent U.S. Pat. No. 4,758,607, or plants under medium vacuum after deactivation of the catalyst, as described in patent application PCT/FR97/00984. The process time is however substantially extended;

compensate for the low polyol functionality by preparing the polyurethane in excess isocyanate (NCO index >150), so as to obtain polyurethanes-isocyanurates. However, the cost of manufacturing the foam, which is linked to the quantity of isocyanate, is greatly increased.

In such a context, it would be particularly advantageous to develop a method which makes it possible to treat composite materials and polyethylene terephthalate and to upgrade the various products recovered without excessive additional cost.

The inventors have had the merit to find, after long and detailed studies, a method for upgrading (using) composite materials consisting in carrying out solvolysis of the composite materials and of polyethylene terephthalate, optionally in the presence of a catalyst, and in separating the solvolysis product containing the products of degradation of the matrix of composite materials and of polyethylene terephthalate from the other constituents of the solid composite materials and from other possible polyethylene terephthalate impurities.

First of all, the method in accordance with the invention makes it possible to separate the products of degradation of the organic matrix of the composite from various other components, in particular from all the reinforcing components and the various metal elements which may be present in the starting material. These reinforcing materials and metal elements may be reused.

Next, most surprisingly, the inventors observed that the solvolysis product resulting from the solvolysis of composite materials and of polyethylene terephthalate is completely stable and suitable for the preparation of polyurethane foams, without resorting to an additional step of correcting or modifying the solvolysis product.

For the purposes of the present invention, the expression “solvolysis product” is understood to mean the product resulting from solvolysis, that is to say the products of degradation of the matrix and/or of the polyethylene terephthalate present in the solvent.

In an advantageous embodiment of the method according to the invention, the solvolysis of the composite material and of the polyethylene terephthalate is carried out simultaneously and then the solvolysis product containing the products of degradation of the matrix of composite materials and of polyethylene terephthalate is separated from the other constituents of the composite materials and from other possible impurities.

This embodiment makes it possible to carry out only one solvolysis step and only one step of separation from the solid materials. In this embodiment, the solvolysis of the composite material and of polyethylene terephthalate may furthermore be carried out in the same reactor.

According to another advantageous embodiment of the method according to the invention, the solvolysis of the composite material is first carried out, the solvolysis product containing the products of degradation of the matrix of the composite materials is then separated from the other constituents of the composite materials, and then the solvolysis product containing the products of degradation of the matrix of composite materials is then used to perform the solvolysis of polyethylene terephthalate.

According to yet another advantageous embodiment of the method according to the invention, the solvolysis of polyethylene terephthalate is first carried out, the solvolysis product containing the products of degradation of the polyethylene terephthalate is then separated from possible polyethylene terephthalate impurities, and then the solvolysis product containing the products of degradation of polyethylene terephthalate is used to perform the solvolysis of the composite materials.

This embodiment has the advantage of providing a large volume of solvolysis products of polyethylene terephthalate (PET) for the solvolysis of the composite materials. Indeed, PET is already solvolyzed and occupies no place in the reactor alongside the composite materials. It also makes it possible to increase the boiling temperature of the reaction mixture. This induces a higher reaction temperature at atmospheric pressure and therefore to increase the reaction rate.

As was already discussed above, polyethylene terephthalate may contain other impurities in particular from stoppers, labels or adhesives used for the manufacture of bottles. These impurities should therefore be separated from the solvolysis product.

The method according to the invention thus has the advantage of recycling all the materials resulting from the solvolysis of composite materials and of polyethylene terephthalate.

In the present application, the expression “glycolysis” is understood to mean the reaction for degradation of the organic matrix under the action of a compound comprising at least two alcohol functional groups or comprising at least one alcohol functional group and also at least one amine functional group.

The solvolysis is performed with the aid of a reactive solvent which may be a polyalcohol or a monoalcohol, or any chemical reagent containing labile hydrogen atoms, such as amines, acids, and the like.

The method in accordance with the invention is particularly suitable for upgrading composite materials whose matrix is a heat-curable resin chosen from the group comprising epoxy resins, polyurethanes, unsaturated polyesters, optionally reinforced and/or deposited on or coating metal elements.

When the organic matrix is reinforced, the reinforcing agent consists of glass, carbon, aramid, and the like, in the form of fibers, chips, fabric, nonwoven, and the like.

According to one embodiment, the method according to the invention is applied to composites based on epoxy resins, in particular epoxy resins containing internal ester bonds, such as some industrial cycloaliphatic resins having the following formula:

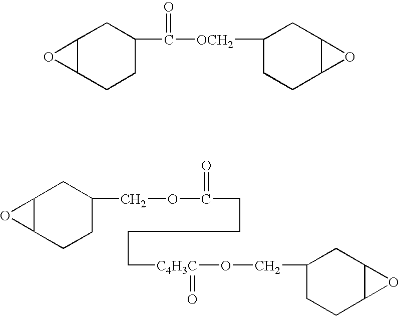

Moreover, this method may also be advantageously applied to any other type of epoxy resin, in particular those of the type including bisphenol A diglycidyl ether (BADGE), bisepoxycyclohexylmethyl adipate, epoxy-novolacs, cured with an acid anhydride, such as hexahydrophthalic anhydride, tetrahydrophthalic anhydride, methylnadic anhydride.

With longer reaction times, the method may also be applied to any type of epoxy resins cured with any type of curing agent, in particular amines such as in particular triethylenetetramine, or epoxy functional group polymerization catalysts.

According to an advantageous embodiment of the method in accordance with the invention, the solvolysis is a glycolysis performed with a solvent chosen from the group comprising glycols, such as ethylene glycol, diethylene glycol, propylene glycol, dipropylene glycol, and the like, polyphenols such as bisphenol A, amino alcohols such as monoethanolamine.

The solvent is present in a volume excess relative to the composite materials. Advantageously, the quantity of solvent is that necessary for the composite material to be completely covered.

According to an advantageous embodiment of the method in accordance with the invention, a catalyst is used which is chosen from conventional transesterification catalysts, such as organometallics derived from titanium, such as tetrabutyl orthotitanate, derivatives of transition metals, in particular of Zn, Mn, Co, and the like, alkali and alkaline-earth metals associated with anions, Brönstedt base, such as hydroxides, oxides, carboxylates, amines, and the like.

The catalyst is used in a quantity at least equal to 0.005%, preferably of between 0.05% and 5%, and still more preferably of about 0.2 to 2% by weight of the total weight of the solvent and of the composite material to be treated.

The quantity of catalyst used of course depends on the composite to be treated and the solvent used. There is no upper maximum value. However, for obvious economic reasons, it is preferable not to exceed 5% by weight relative to the total weight of the solvent and of the composite material to be treated. An optimum quantity is that which makes it possible to obtain total degradation in a relatively short time, preferably less than 10 hours.

According to an advantageous embodiment, the method in accordance with the invention is performed using monoethanolamine as reactive solvolysis solvent; the solvolysis may then be performed without catalyst since monoethanolamine has the advantage of catalyzing itself.

The solvolysis reaction is carried out at high temperature and may be advantageously performed at a temperature of between 120 and 300° C., preferably between 170 and 250° C. and still more preferably between 180 and 240° C., and in a more particularly advantageous manner, for the sake of simplicity, at the boiling point of the solvent.

According to an advantageous embodiment, the method in accordance with the invention comprises the following successive steps consisting in:

shredding the composite materials and the polyethylene terephthalate to be treated into pieces having a size below a size of the order of a few tens of centimeters,

causing these pieces to react in an excess of solvent, optionally in the presence of a catalyst, with gentle stirring, at a temperature between 120 and 300° C. for 0.5 to 12 hours,

separating the solvolysis product from the solid materials,

sorting the various solid materials in order to isolate the metals and the reinforcing materials for their recovery,

optionally freeing the reinforcing materials from any organic material by washing, draining and drying.

According to another advantageous embodiment, the method according to the invention comprises the following successive steps consisting in:

shredding the composite materials to be treated into pieces preferably having a size below a size of the order of a few tens of centimeters,

causing these pieces to react in an excess of solvent, optionally in the presence of a catalyst, with gentle stirring, at a temperature between 120 and 300° C. for 0.5 to 12 hours,

separating the solvolysis product from the solid materials,

sorting the various solid materials in order to isolate the metals and/or the reinforcing materials for their recovery,

optionally freeing the reinforcing materials from any organic material by washing, draining and drying,

using the solvolysis product resulting from the solvolysis of the composite materials for the solvolysis of polyethylene terephthalate.

According to yet another advantageous embodiment, the method according to the invention comprises the following successive steps consisting in:

shredding the polyethylene terephthalate to be treated into pieces preferably having a size below a size of the order of a few tens of centimeters,

causing these pieces to react in an excess of solvent, optionally in the presence of a catalyst, with gentle stirring, at a temperature between 120 and 300° C. for 0.5 to 12 hours,

separating the solvolysis product from possible solid materials, using the solvolysis product resulting from the solvolysis of polyethylene terephthalate for the solvolysis of the composite materials,

separating the solvolysis product from the solid materials,

sorting the various solid materials in order to isolate the metals and/or the reinforcing materials for their recovery,

optionally freeing the reinforcing materials from any organic material by washing, draining and drying.

Advantageously, this method is applied to composites comprising fibers as reinforcing material. Indeed, this method makes it possible to recover fibers which have lost none of their mechanical properties and which can therefore be used in novel upgrading applications.

The method according to the invention also makes it possible to upgrade the solvolysis product of the composite materials and of the polyethylene terephthalate, which essentially consists of polyols, so as to make therefrom polyurethane foams having a completely satisfactory quality. Advantageously, the method according to the invention therefore comprises an additional step of preparing a polyurethane foam from the solvolysis product containing the products of degradation of the matrix of the composite materials and of the polyethylene terephthalate.

The preparation of the polyurethane foam is carried out in a conventional manner, preferably from 1 to 1.1 equivalent(s) of isocyanate relative to the polyols recovered by the method according to the invention. The polyurethane foam obtained according to the invention exhibits good size stability.

In the case where the method in accordance with the invention is used for recycling electronic cards, it is advantageous to carry out a preliminary step of discharging their harmful substances (capacitors, mercury circuit-breakers, batteries, and the like) before applying the method in accordance with the invention.

In the particular case of electronic cards, unlike the current techniques which involve solely the upgrading of recovered metals, all the constituents are isolated and separated and may be reused.

The method in accordance with the invention is particularly useful for upgrading the water pipes of power stations, electronic cards, motor vehicle parts, materials used in the construction industry.

The invention will be described in greater detail using the following examples which are given solely by way of illustration.

### EXAMPLES

### Example 1

### Glycolysis of a Bisphenol A Diglycidyl Ether-Based Resin Cured with Tetrahydrophthalic Anhydride

Identification of the Resin Used:

In this example, there is used a resin based on bisphenol A diglycidyl ether (BADGE) of general formula:

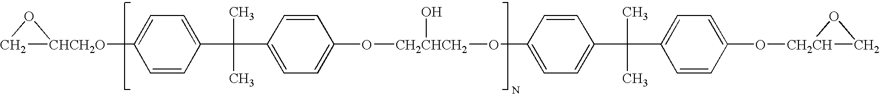

This resin is characterized in that the mean value of N is of the order of 0.15 and the quantity of resin necessary to provide one mole of epoxy equivalent (EEW) is 187 g.

This resin was cured with tetrahydrophthalic anhydride.

The curing was carried out using benzyldimethyleneamine (BDMA) as reaction accelerator in the following manner:

In a reactor, 100 parts by weight of BADGE, 78 parts by weight of tetrahydrophthalic anhydride and 1 part by weight of BDMA are mixed. This mixture was heated for 2 hours at 100° C. and then for 4 hours at 150° C.

### Example 1a

### Glycolysis in Diethylene Glycol

Granular materials of 1 to 2.5 mm in diameter of the resin prepared above are taken. 15 g of these granular materials are placed in 75 ml of diethylene glycol and 98 mg of tetrabutyl orthotitanate are added as catalyst.

After 3 hours of reaction under complete reflux (2450), the granular materials are completely dissolved.

### Example 1b

### Glycolysis in Monoethanolamine

Granular materials of 1 to 2.5 mm in diameter of the resin prepared above are taken. 15 g of these granular materials are placed in 75 ml of monoethanolamine and no catalyst is added.

After 2 hours of reaction under complete reflux (170°), the granular materials are completely dissolved.

It is evident from this example that the glycolysis of an epoxy resin hardened by an anhydride is easy.

### Example 2

### Glycolysis of a Bisphenol A Diglycidyl Ether-Based Resin Hardened with Hexahydrophthalic Anhydride

Resin Used:

The same resin as in Example 1 was used; however, it was cured with the aid of hexahydrophthalic anhydride.

For that, 250.2 g of resin, 196.4 g of hexahydrophthalic anhydride and 2.6 g of benzyldimethylamine were used.

This reactive mixture was poured on a tray and a plate having a mean thickness of 3 mm was obtained. This plate was broken in order to obtain granular materials of different sizes which were separated by sieving in order to obtain the following batches:

Batch 1: 0.3×4×5 cm

Batch 2: 1 to 2.5 mm

Batch 3: 0.63 to 1 mm

Batch 4: <0.63 mm

Various glycolysis trials were carried out at a temperature of 245° C.

A first series of trials (trials 1 to 5) were carried out in various quantities of diethylene glycol in the presence of tetrabutyl orthotitanate, and then a second series of trials (trials 6 to 8) was carried out in monoethanolamine in the absence of catalyst.

In each case, the time necessary for complete dissolution of the granular materials was determined.

The trial conditions and the results obtained are presented in Tables 1 and 2 below.

TABLE 1
Glycolysis in diethylene glycol (DEG)

| | Trial 1 | Trial 2 | Trial 3 | Trial 4 | Trial 5 |
|---|---|---|---|---|---|
| Granular | Batch 1 | Batch 2 | Batch 4 | Batch 3 | Batch 1 |
| materials | | | | | |
| Resin | 17.7 | 15 | 15 | 15 | 15 |
| mass (g) | | | | | |
| DEG volume | 88.5 | 75 | 75 | 25 | 25 |
| (ml) | | | | | |
| Catalyst | 0.08 | 0.098 | 0.082 | 0.087 | 0.079 |
| (g) | | | | | |
| Reaction | 8 | 3 | 3 | 1.5 | 5 |
| time (h) | | | | | |

TABLE 2
Glycolysis in monoethanolamine (MEA)

| | Trial 6 | Trial 7 | Trial 8 |
|---|---|---|---|
| Granular materials | Batch 1 | Batch 2 | Batch 4 |
| Resin mass (g) | 16.5 | 15.1 | 15 |
| MEA volume (ml) | 82.5 | 74.6 | 73.6 |
| Reaction time (h) | 3.5 | 1.65 | 3 |

### Example 2b

Three trials were then carried out (trials 9 to 11), 10 varying the quantity of catalyst used. In these trials 15 g of the resin of this example, in the form of granular materials of 1-1.25 mm placed in 75 ml of DEG, were used.

Various quantities of orthotitanate were added as indicated in Table 3 below and for each of the trials, the time for termination of dissolution was measured.

These values are given in Table 3.

TABLE 3
Influence of the catalyst

| | Trial 9 | | Trial 10 | | Trial 11 | |
|---|---|---|---|---|---|---|
| Catalyst (mg) | 98 | | 0 | | 300 | |
| Time | 3 | h | more than 16 | h | <1 | h 45 |
| Oligomers M | 5% | | 52% | | 5% | |
| >1000 g/mol* | | | | | | |

*Analysis by size exclusion chromatography.

### Example 3

### Glycolysis of a Glass/Anhydride Cured BADGE Epoxy

A tube was taken which is used for the circulation of water in the safety systems in power stations. These tubes are made of epoxy resin marketed by the company SEPMA under the name CIBA LY 556 (bisphenol A) with the aid of an anhydride-type curing agent, they are reinforced with glass fiber filamentary coils with a silane-type sizing.

These tubes were crushed so as to obtain pieces of about 4×5×0.5 cm.

In the 500 ml reactor, 30.8 g of this composite in pieces were added to 162.25 g of DEG and 0.055 g of tetrabutyl orthotitanate. This mixture was stirred for 8 hours at 245° C. under a continuous nitrogen stream.

In less than two hours, the fibers begin to be released.

Once the reaction terminated, the mixture was filtered. Two fractions were obtained: the product of glycolysis, a mixture of polyols and of DEG, and the fibers impregnated with the product of glycolysis.

The fibers were washed with benzyl alcohol and then with acetone.

The rinse filtrate was then mixed with the product of glycolysis after distillation of the methanol using a rotary evaporator.

Analysis of the polyols recovered shows that they are identical to those obtained in Example 2b.

### Example 4

### Glycolysis of a Triethylinetetramine-Cured BADGE Epoxy Resin

Resin Identification:

200 g of BADGE were cured with 28 g of triethylenetetramine (TETA) with no catalyst, for 7 days at room temperature, and then for 2 hours at 200° C.

Glycolysis

14.66 g of the cured epoxy resin obtained above, 73.5 g of DEG and 0.08 g of tetrabutyl orthotitanate were introduced into a reactor.

The mixture was allowed to react at 245° C. for 14 hours.

At the end of 14 h, the glycolysis is complete.

### Example 5

A new electronic card not equipped with components was used in this example. This card consists of several layers of epoxy resin reinforced with glass fibers.

Sheets of copper and of other types of metal are intercalated between these layers.

This card (70.6 g) was cut into pieces. The pieces were introduced into a reactor with 353.5 g of DEG and 0.4 g of tetrabutyl orthotitanate. The glycolysis was carried out at 245° C. for 12 h 30 min, with gentle stirring initially, and then with a more vigorous stirring of the reaction medium. During this reaction, various samples were taken in order to monitor this reaction.

Analyses by size exclusion chromatography showed that after 2 hours of reaction, the composition of the product of glycolysis no longer varied. The product of glycolysis obtained is a mixture rich in oligomers.

UV analyses show a gradual increase in the absorbance at 278 nm and 285 nm. Between 2 h 15 min and 8 h 30 min of reaction, the absorbance increased from 0.22 to 0.6.

The IR and UV analyses prove that the resin is rather of the aromatic type, probably of the family of BADGE resins. However, this absorption could also result from a curing agent of the aromatic amine type. The curing agent is not an acid anhydride.

These results show that the depolymerization which leads to species soluble in DEG is slow. By contrast, after having undergone a fairly extensive depolymerization so as to be soluble, the molar mass of the products of glycolysis are thought not to undergo variation during an additional period of glycolysis.

Once the reaction terminated, there were recovered by filtration, on the one hand, 263.7 g of product of glycolysis (product of glycolysis 1) and, on the other hand, glass fibers filled with product of glycolysis and the metals.

The metals were washed with methyl alcohol and then dried.

The glass fibers were drained, the product of glycolysis thus removed 50.6 g (product of glycolysis 2) was added to the product of glycolysis 1.

These drained glass fibers were washed with 1.2 l of dimethylformamide and then with 1 l of methyl alcohol, and they were dried.

After this drying, the glass fibers were manually separated from the small pieces of metal which were added to those previously isolated.

The glass fibers were mainly in the form of a mat, but also in the form of a fabric. 35.5 g of glass fibers and 9 g of metals were thus recovered.

The products of glycolysis 1 and 2 were distilled and DEG and polyols were thus recovered.

### Example 6

### Preparation of Polyols from the Solvolysis of Cured Resin and of Polyethylene Terephthalate According to the Invention

Glycolysis of a BADGE/HP cured resin, which exists in a broad particle size range (pieces from less than 1 mm to pieces of 30×40 mm), is carried out in accordance with Example 1.a with DEG in the presence of tetrabutyl orthotitanate as catalyst.

The initial composition is the following:

100 g of cured resin;

159 g of DEG;

0.51 g of Ti(OBu)₄.

After 3 hours of heating under reflux, all the small sized solid fragments disappeared and 6.5 hours of heating under reflux were necessary in order to observe complete disappearance of the large sized fragments.

91 g of granulated PET (waste from the manufacture of bottle preforms) at about 2 mm are then added. The PET is “dissolved” in less than 1.5 hours, with heating under reflux. The heating is further maintained for 1 hour.

350 g of a composition of polyols with a hydroxyl value of (OH)=481 and a mean functionality of 2.22 are recovered. These values are obtained by calculation.

The product obtained has a storage stability of more than 6 months.

### Example 7

### Preparation of a Polyurethane Foam from Polyols Obtained in Example 6

A polyurethane foam is prepared from polyols obtained from Example 6.

Just after adding the conventional additives (DMCHA (catalyst), SR 242 (stabilizer), HCFC 141b (foaming agent)) and homogenizing, in a cup, the polyol of Example 6, the quantity of isocyanate (PMDI at 31.2% of NCO (isocyanate)) corresponding to an NCO index of 110 is added.

The mixture is then stirred with a revolving blade at 2000 revolutions/minute (time zero at the start of stirring). After 10 to 20 seconds of stirring, the mixture is poured into a parallelepipedal container (1×L×h: 15/17/18 cm), where the foam is allowed to expand freely. After 4 days of maturation at room temperature, the foam is cut into cubes for characterization. This foam is designated by the reference (7).

By way of comparison, a polyurethane foam is prepared according to the same procedure from a composition of polyols (designated by the reference polyol PET) having a functionality of 2.00, obtained by glycolysis/esterification of the PET. After 4 days of maturation at room temperature, the foam is cut into cubes for characterization. This foam is designated by the reference (GLY 23).

The conventional characteristics of these foams, that is to say the cream time (T cream), the gel time (T gel) and the tack free time (T tack) are measured.

The characterization of the foams obtained is presented in Table 4 below:

TABLE 4
Comparison of the foams (7) and (GLY 23):

| Composition | Foam (7) | | Foam (GLY 23) | |
|---|---|---|---|---|
| Polyol Ex. 6 | 100 | g | / | |
| Polyol PET* | / | | 100 | g |
| Water | 1 | g | 1 | g |
| DMCHA | 0.5 | g | 0.5 | g |
| SR 242 | 2 | g | 2 | g |
| HCFC 141 b | 20 | g | 20 | g |
| PMDI (index 110) | 135 | g | 96 | g |
| T cream | 112 | seconds | 38 | seconds |
| T gel | 161 | seconds | 81 | seconds |
| T tack free | 172 | seconds | 122 | seconds |
| Density | 0.0369 | | 0.0347 | |

*The polyol PET is a polyol obtained from 96 g of PET, 97.5 g of DEG, 26.8 g of DPG, 29.2 g of adipic acid, 29.6 g of phthalic anhydride. It has a functionality of 2.00, a hydroxyl value of 290 and a storage stability of about 3 months. To obtain a functionality comparable to that of the polyol Ex. 6, it would have been necessary to add 10% by mass of glycerol.

A test of aging in the open air is performed over one week to one year.

At the end of one week, the cubes cut out of the foam (7) show no notable deformation unlike those of the foam (GLY 23) which begin to become deformed.

At the end of one year, the cubes cut out of the foam (7) show no notable deformation; by contrast, those of the foam (GLY 23) are greatly deformed.

When they are subjected to a pressure of 0.27 kg/cm² with a temperature of 60° C., the cubes of the foam (7) show limited deformation while those of the foam (GLY 23) are completely crushed.

1. A method for using composite materials and polyethylene terephthalate consisting in carrying out solvolysis of the composite materials and of polyethylene terephthalate, optionally in the presence of a catalyst, and in separating the solvolysis product containing the products of degradation of the matrix of composite materials and of polyethylene terephthalate from the other constituents of the composite materials and from other possible polyethylene terephthalate impurities.

2. The method as claimed in claim 1, wherein the solvolysis of the composite material and of the polyethylene terephthalate is carried out simultaneously and then the solvolysis product containing the products of degradation of the matrix of composite materials and of polyethylene terephthalate is separated from the other constituents of the composite materials and from other possible polyethylene terephthalate impurities.

3. The method as claimed in claim 1, wherein the solvolysis of the composite material is first carried out, the solvolysis product containing the products of degradation of the matrix of the composite materials is then separated from the other constituents of the composite materials, and then the solvolysis product containing the products of degradation of the matrix of composite materials is then used to perform the solvolysis of polyethylene terephthalate.

4. The method as claimed in claim 1, wherein the solvolysis of polyethylene terephthalate is first carried out, the solvolysis product containing the products of degradation of the polyethylene terephthalate is then separated from possible impurities, and then the solvolysis product containing the products of degradation of polyethylene terephthalate is used to perform the solvolysis of the composite materials.

5. The method as claimed in any one of claims 1 to 4, wherein the composite materials comprise a matrix which is a heat-curable resin selected from the group comprising epoxy resins, polyurethanes, unsaturated polyesters, said resin being optionally reinforced and being deposited on or coating metal elements.

6. The method as claimed in either claim 1 or claim 5, wherein the matrix is reinforced with glass, carbon, aramid, and the like, in the form of fibers, chips, fabric, nonwoven, and the like.

7. The method as claimed in any one of claims 1 to 6, wherein the solvolysis is carried out using an excess of reactive solvent selected from the group comprising chemical reagents containing a labile hydrogen such as monoalcohols, amines, acids, preferably from the group comprising glycols, such as ethylene glycol, propylene glycol, diethylene glycol, dipropylene glycol, polyphenols such as bisphenol A, amino alcohols such as monoethanolamine.

8. The method as claimed in any one of claims 1 to 7, wherein the catalyst is selected from the group comprising conventional transesterification catalysts, such as organometallics derived from titanium, such as tetrabutyl orthotitanate, derivatives of transition metals, in particular of Zn, Mn, Co, alkali and alkaline-earth metals associated with anions, Brönstedt base, such as hydroxides, oxides, carboxylates and amines.

9. The method as claimed in any one of claims 1 to 8, wherein the catalyst is used in a quantity greater than or equal to 0.005%, preferably of between 0.05% and 5%, and still more preferably of about 0.2 to 2% by weight relative to the total weight of the composite and of the solvent.

10. The method as claimed in any one of claims 1 to 9, wherein the glycolysis is carried out at a temperature of 120° to 300° C., preferably of 170° to 250° C., still more preferably of 180° and 240° C.

11. The method as claimed in any one of claims 2 and 5 to 10, comprising the following successive steps consisting in:
shredding the composite materials and the polyethylene terephthalate to be treated into pieces having a size below a size of the order of a few tens of centimeters,
causing these pieces to react in an excess of solvent, optionally in the presence of a catalyst, with gentle stirring, at a temperature between 120 and 300° C. for 0.5 to 12 hours,
separating the solvolysis product from the solid materials,
sorting the various solid materials in order to isolate the metals and the reinforcing materials for their recovery,
optionally freeing the reinforcing materials from any organic material by washing, draining and drying.

12. The method as claimed in any one of claims 3 and 5 to 10, comprising the following successive steps consisting in:
shredding the composite materials to be treated into pieces preferably having a size below a size of the order of a few tens of centimeters,
causing these pieces to react in an excess of solvent, optionally in the presence of a catalyst, with gentle stirring, at a temperature between 120 and 300° C. for 0.5 to 12 hours,
separating the solvolysis product from the solid materials,
sorting the various solid materials in order to isolate the metals and/or the reinforcing materials for their recovery,
optionally freeing the reinforcing materials from any organic material by washing, draining and drying,
using the solvolysis product resulting from the solvolysis of the composite materials for the solvolysis of polyethylene terephthalate.

13. The method as claimed in any one of claims 4 to 10, comprising the following successive steps consisting in:
shredding the polyethylene terephthalate to be treated into pieces preferably having a size below a size of the order of a few tens of centimeters,
causing these pieces to react in an excess of solvent, optionally in the presence of a catalyst, with gentle stirring, at a temperature between 120 and 300° C. for 0.5 to 12 hours,
separating the solvolysis product from possible solid materials,
using the solvolysis product resulting from the solvolysis of polyethylene terephthalate for the solvolysis of the composite materials,
separating the solvolysis product from the solid materials,
sorting the various solid materials in order to isolate the metals and/or the reinforcing materials for their recovery,
optionally freeing the reinforcing materials from any organic material by washing, draining and drying.

14. The method as claimed in any one of claims 1 to 13, comprising an additional step of preparing a polyurethane foam from the solvolysis product containing the products of degradation of the matrix of the composite materials and of the polyethylene terephthalate.

15. The use of the method as claimed in any one of claims 1 to 14, for upgrading the water pipes of power stations, electronic cards, motor vehicle parts, materials used in the construction industry and the polyethylene terephthalate industry, in particular for the manufacture of polyurethane foam.
